(19) United States
(12) Patent Application Publication
(10) Pub. No.: US 2026/0359729 A1
(43) Pub. Date: Nov. 12, 2026

(54) METHOD FOR PATTERN RECALLING, AND METHOD FOR TRAINING A MEMORY BRANCH NETWORK, ELECTRONIC DEVICE AND STORAGE MEDIUM

(71) Applicant: BEIJING BAIDU NETCOM SCIENCE TECHNOLOGY CO., LTD., Beijing (CN)

(72) Inventors: Jingbo Zhou, Beijing (CN); Bowen Yang, Beijing (CN); Hua Wu, Beijing (CN)

(73) Assignee: BEIJING BAIDU NETCOM SCIENCE TECHNOLOGY CO., LTD., Beijing (CN)

(21) Appl. No.: 19/722,015

(22) Filed: Jun. 26, 2026

(30) Foreign Application Priority Data
Mar. 20, 2026 (CN) 202610352758.4

(51) Int. Cl. G06N 20/00; G06F 40/284; G06F 40/40

(52) U.S. Cl. CPC G06N 20/00; G06F 40/284; G06F 40/40

(57) ABSTRACT

The present disclosure provides a method for recalling a pattern, and a method and an apparatus for training a memory branch network. The present disclosure relates to a field of large model technology, and specifically to a field of artificial intelligent (AI) such as natural language processing. The method includes: obtaining a target memory branch network of a large model, and obtaining, through the target memory branch network, an associated latent feature representation of an input token sequence in an input text of the large model; obtaining a set of reference patterns of the large model; and obtaining a target pattern of the input token sequence by performing, based on the associated latent feature representation and the set of reference patterns, a recall of a pattern corresponding to the input token sequence.

### CROSS REFERENCE TO RELATED APPLICATIONS

This application claims priority and benefits to Chinese Application No. 202610352758.4, filed on Mar. 20, 2026, the entire content of which is incorporated herein by reference.

### TECHNICAL FIELD

The present disclosure relates to the field of large model technology, and specifically to a field of artificial intelligent (AI) such as natural language processing.

### BACKGROUND

During the operation of a large model, it is often necessary to recall historical patterns. In related technologies, pattern reconstruction may be performed token by token based on extracted token-level feature representations, which leads to poor efficiency.

### SUMMARY

The present disclosure provides a method for recalling a pattern, a method for training a memory branch network, and a method for training a classification model.

According to a first aspect, the embodiments of the present disclosure provide a method for recalling a pattern, including: obtaining a target memory branch network of a large model, and obtaining, through the target memory branch network, an associated latent feature representation of an input token sequence in an input text of the large model; obtaining a set of reference patterns of the large model; and obtaining a target pattern of the input token sequence by performing, based on the associated latent feature representation and the set of reference patterns, a recall of a pattern corresponding to the input token sequence.

According to a second aspect, the embodiments of the present disclosure provide a method for training a memory branch network, including: obtaining a first candidate memory branch network to be trained, and obtaining a second candidate memory branch network by training a candidate encoder, a first candidate sparse function and a candidate codebook matrix corresponding to the first candidate memory branch network; and obtaining a trained target memory branch network by training a second candidate sparse function in the second candidate memory branch network, in which the target memory branch network is configured to implement the method for recalling a pattern in the above first aspect.

According to a third aspect, the embodiments of the present disclosure provide an electronic device, including: at least one processor; and a memory communicatively coupled to the at least one processor; in which the memory stores instructions that, when executed by the at least one processor, cause the at least one processor to perform the method for recalling a pattern in the above first aspect and/or the method for training a memory branch network in the above second aspect.

According to a fourth aspect, the embodiments of the present disclosure provide a non-transitory computer-readable storage medium for storing computer instructions, in which the computer instructions are configured to cause a computer to perform the method for recalling a pattern in the above first aspect and/or the method for training a memory branch network in the above second aspect.

### BRIEF DESCRIPTION OF THE DRAWINGS

The accompanying drawings are used for better understanding of the present solution and do not constitute a limitation on the present disclosure.

FIG. 1 is a flowchart of a method for recalling a pattern according to an embodiment of the present disclosure.

FIG. 2 is a flowchart of a method for recalling a pattern according to another embodiment of the present disclosure.

FIG. 3 is a flowchart of a method for recalling a pattern according to another embodiment of the present disclosure.

FIG. 4 is a flowchart of a method for training a memory branch network according to an embodiment of the present disclosure.

FIG. 5 is a flowchart of a method for training a memory branch network according to another embodiment of the present disclosure.

FIG. 6 is a flowchart of a method for training a memory branch network according to another embodiment of the present disclosure.

FIG. 7 is a block diagram of an apparatus for training a memory branch network according to an embodiment of the present disclosure.

FIG. 8 is a block diagram of an apparatus for training a classification model according to an embodiment of the present disclosure.

FIG. 9 is a block diagram of an electronic device according to an embodiment of the present disclosure.

### DETAILED DESCRIPTION

Exemplary embodiments of the disclosure are described hereinafter in conjunction with the accompanying drawings, which include various details of the embodiments of the disclosure in order to aid in understanding, and should be considered exemplary only. Accordingly, one of ordinary skill in the art should recognize that various changes and modifications may be made to the embodiments described herein without departing from the scope and spirit of the disclosure. Similarly, descriptions of well-known features and structures are omitted from the following description for the sake of clarity and brevity.

A large language model (LLM) refers to a deep learning model trained using a large amount of text data, enabling the model to generate natural language text or understand the meaning of language text. The model can provide in-depth knowledge and language production on various topics by be trained on massive datasets. The core idea is to learn patterns and structures of natural language through large-scale unsupervised training, simulating human language cognition and generation processes to a certain extent.

Natural language processing (NLP) is an important direction in the field of computer science and artificial intelligence. It studies various theories and methods that enable effective communication between humans and computers using natural language. NLP is a science that integrates linguistics, computer science, and mathematics. NLP is mainly applied in machine translation, public opinion monitoring, automatic summarization, opinion extraction, text classification, question answering, text semantic comparison, speech recognition, Chinese optical character recognition (OCR), and so on.

Artificial intelligence (AI) is an important driving force of the new round of technological revolution and industrial transformation. It is a new technical science that studies and develops theories, methods, technologies and application systems for simulating, extending and expanding human intelligence. AI is an important component of the discipline of intelligent, as it attempts to understand the essence of intelligence and produce new intelligent machines that can react in ways similar to human intelligence. AI is a very broad science, including robotics, speech recognition, image recognition, natural language processing, expert systems, machine learning, computer vision, etc.

It needs to be noted that acquisition, storage, use, and processing of data in the technical solution of the present disclosure comply with relevant laws and regulations of the country and do not violate public order and moral.

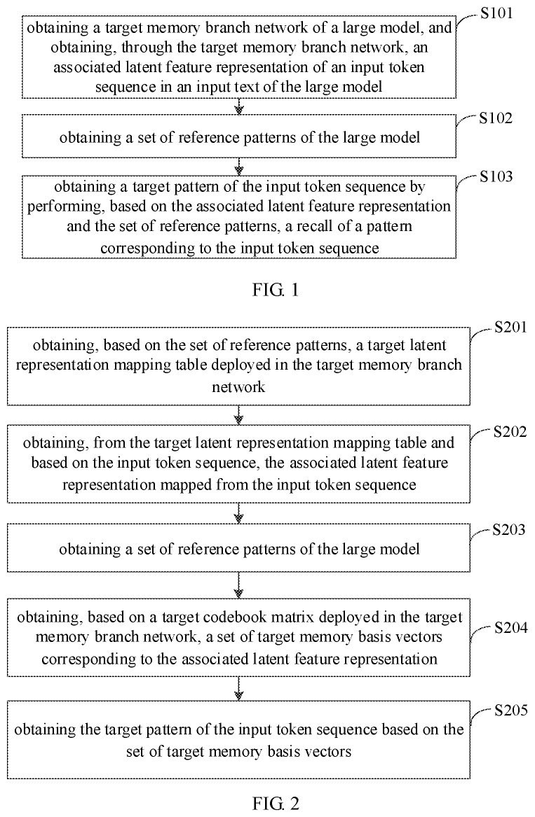

FIG. 1 is a flowchart of a method for recalling a pattern according to an embodiment of the present disclosure. As shown in FIG. 1, the method includes the following steps at S101 to S103.

At S101, a target memory branch network of a large model is obtained, and, through the target memory branch network, an associated latent feature representation of an input token sequence in an input text of the large model is obtained.

During the operation of the large model, it may be necessary to recall patterns that have appeared within a historical time range. A pattern may be understood as structural feature information and regular feature information that repeatedly appear during the historical operation of the large model. A pattern may include dependency relationships between elements in a sequence, relevant features of attention weight distribution, general language and visual patterns, and may also include recurring phrase expressions, structured templates, and domain-specific expressions, etc., which are not specifically limited here.

In the embodiments of the present disclosure, a corresponding branch network may be constructed on a relevant model layer of the large model, and the branch network may be used to perform a recall operation for patterns required during the operation of the large model. The branch network may be determined as the target memory branch network of the large model.

The target memory branch network may be constructed based on a factorized memory mechanism in related technologies, or may be constructed based on other types of mechanisms, which are not specifically limited here.

In the embodiments of the present disclosure, the target memory branch network may be connected to a backbone network of the large model using a branch network connection method in related technologies. When the large model connected with the target memory branch network obtains a pattern, it can recall a relevant pattern through the target memory branch network and transmit it back to the backbone network of the large model to participate in the operation of the large model.

In the embodiments of the present disclosure, the target memory branch network can recall a relevant pattern based on a sequence composed of a plurality of tokens. The sequence composed of the plurality of tokens may be determined as the input token sequence.

It needs to be noted that the input token sequence may be obtained by performing corresponding token extraction on the input text based on the large model. After extracting the input token sequence, the large model may transmit the input token sequence to a data input port of the target memory branch network for subsequent pattern recall operations.

Alternatively, token extraction may also be performed on the input text through a token extraction layer deployed in the target memory branch network to obtain the input token sequence carried in the input text, which is not specifically limited here.

In the embodiments of the present disclosure, the target memory branch network is deployed with a corresponding algorithm for obtaining a latent feature representation. Based on the algorithm, the input token sequence may be processed, and a latent representation associated with the input token sequence may be obtained based on a result of the processing, and may be determined as the associated latent feature representation corresponding to the input token sequence.

The algorithm for obtaining the latent feature representation deployed in the target memory branch network may be implemented by a sparse mapping function in related technologies, or may be implemented by other functions, which are not specifically limited here.

It needs to be noted that the associated latent feature representation has certain degree of association with the relevant pattern to be recalled. That is, based on the association corresponding to the associated latent feature representation, the recall of the relevant pattern based on the input token sequence may be achieved.

At S102, a set of reference patterns of the large model is obtained.

In the embodiments of the present disclosure, patterns that appear during the operation of the large model within a set historical time range may be collected to obtain a set of historical patterns of the large model within the historical time range.

In this scenario, the set of historical patterns may be filtered based on a preset filtering condition for reference patterns, and patterns matching the filtering condition may be determined as reference patterns corresponding to the large model. Then, the set of reference patterns may be obtained based on the reference patterns.

It needs to be noted that each reference pattern in the set of reference patterns may be understood as a historical pattern whose appearance frequency within the set historical time range is above a preset threshold.

At S103, a target pattern of the input token sequence is obtained by performing, based on the associated latent feature representation and the set of reference patterns, a recall of a pattern corresponding to the input token sequence.

In the embodiments of the present disclosure, the target memory branch network is deployed with a recalling algorithm for patterns. In this scenario, the recall of the pattern corresponding to the input token sequence can be achieved based on the associated latent feature representation and the set of reference patterns through the recall algorithm.

That is, through the recall algorithm deployed in the target memory branch network, based on the association between the associated latent feature representation and the set of reference patterns, the recall of the pattern corresponding to the input token sequence can be achieved. The associated latent feature representation and the set of reference patterns may be processed by the recall algorithm, and the pattern corresponding to the input token sequence may be obtained based on a result of the processing. The pattern may be determined as the target pattern of the input token sequence.

According to the method for recalling a pattern proposed in the present disclosure, the target memory branch network of the large model is obtained, and the associated latent feature representation of the input token sequence is obtained through the target memory branch network. Then, based on the associated latent feature representation and the set of reference patterns, pattern recall is performed on the input token sequence to obtain the target pattern. In the present disclosure, adding the target memory branch network to the backbone network of the large model, there is no need to train the large model, which reduces the optimization cost of the large model and improves the optimization efficiency of the large model. By performing target pattern recall through the associated latent feature representation, there is no need to rely on an attention mechanism of the large model for token by token pattern reconstruction, which improves the efficiency of obtaining the target pattern and improves the adaptability between the target pattern and the input token sequence. By adding the target memory branch network to the large model, a path for obtaining patterns of the large model is increased, the method for obtaining patterns is optimized, the operating efficiency of the large model is improved, and thus the model performance of the large model is optimized.

In the above embodiment, the acquisition of the target pattern may be further understood with reference to FIG. 2. FIG. 2 is a flowchart of a method for recalling a pattern according to another embodiment of the present disclosure. As shown in FIG. 2, the method includes the following steps at S201 to S205.

At S201, based on the set of reference patterns, a target latent representation mapping table deployed in the target memory branch network is obtained.

In the embodiments of the present disclosure, the target latent representation mapping table is deployed in the large model. Based on the target latent representation mapping table, latent representations having a mapping relationship with a preset token sequence can be obtained, in which a latent representations has an index relationship with a memory basis vector in a target codebook matrix.

In this scenario, the target latent representation mapping table deployed in the target memory branch network may be obtained based on the set of reference patterns.

In some embodiments, a reference pattern feature vector for each reference pattern in the set of reference patterns is obtained through a target embedding space in the target memory branch network.

In the embodiments of the present disclosure, an embedding space is deployed in the target memory branch network, which may be determined as the target embedding space deployed in the target memory branch network.

In this scenario, each reference pattern in the set of reference patterns may be encoded through an algorithm deployed in the target embedding space, and feature vector of each reference pattern, i.e., reference pattern feature vector of each reference pattern, is obtained based on a result of the encoding.

As an example, assuming the reference pattern is p, encoding p through the target embedding space yields a reference pattern feature vector e^{p} for the reference pattern p.

In some embodiments, sparse mapping is performed on each reference pattern feature vector through a target sparse function in the target memory branch network to obtain a reference latent feature representation for each reference pattern feature vector.

In the embodiments of the present disclosure, the sparse mapping function deployed in the target memory branch network may be determined as the target sparse function. In this scenario, the sparse mapping may be performed on each reference pattern feature vector based on the target sparse function, and a sparse vector obtained after the sparse mapping is determined as a reference latent feature representation of each reference pattern feature vector.

Based on the above example, for the reference pattern feature vector e^{p} of the reference pattern p, the sparse mapping is performed on it, and the sparse vector obtained after the sparse mapping is determined as the reference latent feature representation φ′(e^{p}) of the reference pattern feature vector e^{p}, where φ′( ) represents the target sparse function.

In some embodiments, the target latent representation mapping table is constructed based on reference patterns and reference latent feature representations.

In the embodiments of the present disclosure, for any reference pattern, by performing sparse mapping on the reference pattern feature vector of the reference pattern through the target sparse function, the reference latent feature representation corresponding to the reference pattern can be obtained. It can be seen that there is a correspondence between the reference latent feature representation and the reference pattern.

In this scenario, a mapping relationship between any reference pattern and its corresponding reference latent feature representation may be determined based on the correspondence between reference patterns and reference latent feature representations. Then, a corresponding mapping table is obtained based on the reference patterns, the reference latent feature representations and the relevant mapping relationships through a mapping table construction algorithm in related technologies, and the mapping map is determined as the target latent representation mapping table.

At S202, based on the input token sequence and from the target latent representation mapping table, the associated latent feature representation mapped from the input token sequence is obtained.

In the embodiments of the present disclosure, the target latent representation mapping table may store a latent representation having a mapping relationship with the input token sequence. In this scenario, a table lookup algorithm in related technologies may be used to look up the target latent representation mapping table based on the input token sequence, and based on a lookup result, the latent feature representation mapped from the input token sequence is obtained from the target latent representation mapping table, and the latent feature representation may serve as the associated latent feature representation of the input token sequence.

It needs to be noted that the target latent representation mapping table may not store a latent feature representation having a mapping relationship with the input token sequence. In this scenario, the target latent representation mapping table needs to be updated.

In some embodiments, in response to the input token sequence not being hit in the target latent representation mapping table, an accumulative occurrence count of the input token sequence is updated.

In the embodiments of the present disclosure, a case where the target latent representation mapping table does not store the latent feature representation having the mapping relationship with the input token sequence may be determined as the input token sequence not being hit in the target latent representation mapping table. In this scenario, the latent feature representation having the mapping relationship with the input token sequence may be obtained, and the target latent representation mapping table may be updated based on the input token sequence and the latent feature representation.

In this scenario, a historical accumulative occurrence count of the input token sequence in the large model and the target memory branch network may be obtained, and a current occurrence count is added to the historical accumulative occurrence count to update the accumulative occurrence count of the input token sequence.

As an example, when the input token sequence not being hit in the target latent representation mapping table, the input token sequence may be marked as a key of the pattern and recorded in a local cache, in which the accumulative occurrence count of the input token sequence may also be recorded in the local cache.

In some embodiments, in response to an updated accumulative occurrence count being greater than or equal to a preset occurrence count threshold, the target sparse function and the target latent representation mapping table are updated based on the input token sequence.

In the embodiments of the present disclosure, the updated accumulative occurrence count may be compared with the preset occurrence count threshold. When the updated accumulative occurrence count is greater than or equal to an occurrence count threshold, it may be determined that the pattern corresponding to the input token sequence is a pattern whose occurrence frequency in the large model and the target memory branch network satisfies a set condition, and it is necessary to update the target sparse function and the target latent representation mapping table deployed in the target memory branch network based on the input token sequence and the pattern, so that when the input token sequence appears again subsequently, the associated latent feature representation of the input token sequence may be obtained through the target latent representation mapping table.

In some embodiments, context information is collected respectively on an input text to which the input token sequence belongs at each occurrence of the input token sequence, so as to obtain a set of input contexts corresponding to the input token sequence.

In the embodiments of the present disclosure, the input text at each occurrence of the input token sequence may be obtained, and context information of the input token sequence in the plurality of input texts may be collected to obtain the context information of the input token sequence in the plurality of input texts. The context information may be determined as the input context of the input token sequence, and then the set of input contexts of the input token sequence is obtained based on a collected input context.

In some embodiments, an input pattern feature vector corresponding to the input token sequence is obtained based on the set of input contexts through the target encoding space in the target memory branch network.

In the embodiments of the present disclosure, the pattern corresponding to the input token sequence may be encoded through the target embedding space in the target memory branch network based on the set of input contexts, and a vector obtained by a target embedding space is determined as the input pattern feature vector of the input token sequence obtained by the set of input contexts.

As an example, assuming the set of input contexts is C, the algorithmic process for obtaining the input feature vector through the target embedding space based on the set of input contexts C may be as follows:

$${e}_{new}^{p} = \frac{1}{\vert C \vert} {\sum }_{ω ∈ C} {e}_{ω}$$

$${e}_{new}^{p}$$

represents an input feature vector of the input token sequence that was not found, C represents the set of input contexts, ω represents each input context in the set of input contexts, and e_{ω} represents a feature vector of the input context.

As another example, the input feature vector may also be obtained using the following algorithm:

$${e}_{new}^{p} = {\sum }_{ω ∈ C} {α}_{ω} {e}_{ω}$$

$${e}_{new}^{p}$$

represents the input feature vector of the input token sequence that was not found, C represents the set of input contexts, ω represents each input context in the set of input contexts, and α_{ω} represents a distance weight.

In some embodiments, an update, based on the input pattern feature vector, of a target sparse function, the target latent representation mapping table, and a target codebook matrix in the target memory branch network is performed.

A candidate updated sparse function for the target sparse function may be obtained, and a trained target updated sparse function is obtained by training the candidate updated sparse function based on the input pattern feature vector.

In the embodiments of the present disclosure, based on the target sparse function deployed in the target memory branch network, a sparse function used when updating and replacing the target sparse function may be obtained as a target updated sparse function for the target sparse function. Before the target sparse function is updated by the target updated sparse function, the target sparse function needs to be trained and optimized accordingly. An updated sparse function that needs to be trained and optimized may be determined as the candidate updated sparse function, and the updated sparse function is trained based on the input pattern feature vector to obtain the trained target updated sparse function.

In some embodiments, a mapped latent feature representation of the input pattern feature vector is obtained by performing, through the candidate updated sparse function, sparse mapping on the input pattern feature vector.

In the embodiments of the present disclosure, the sparse mapping may be performed on the input pattern feature vector through the candidate updated sparse function, and the sparse vector obtained by the sparse mapping is determined as the mapped latent feature representation corresponding to the input pattern feature vector.

As an example, assuming the candidate updated sparse function is φ″( ), the mapped latent feature representation obtained after performing the sparse mapping on the input pattern feature vector

$${e}_{new}^{p}$$

through the candidate updated sparse function φ″( ) can be expressed as

$${φ}^{″} ( {e}_{new}^{p} ) .$$

In some embodiments, a corresponding reconstructed pattern feature vector is obtained by performing pattern reconstruction based on the mapped latent feature representation and the target codebook matrix.

In the embodiments of the present disclosure, a memory basis vector associated with the mapped latent feature representation may be obtained from the target codebook matrix. A pattern reconstruction algorithm in related technologies is used to perform vector reconstruction processing of the pattern based on the memory basis vector. Then, based on a result of the algorithmic processing, a corresponding reconstructed feature vector is obtained as the reconstructed pattern feature vector.

In some embodiments, a function training loss of the reconstructed pattern feature vector relative to the input pattern feature vector is obtained, and the target updated sparse function is obtained by training the candidate updated sparse function based on the function training loss until a training end condition is satisfied.

In the embodiments of the present disclosure, a loss value algorithm in related technologies may be used to perform the algorithmic processing on the reconstructed pattern feature vector and the input pattern feature vector to obtain a loss value of the reconstructed pattern feature vector relative to the input pattern feature vector, and the loss value is determined as a function training loss of the candidate updated sparse function.

In this scenario, a function optimization method in related technologies may be used to optimize the candidate updated sparse function based on the function training loss until the training end condition is satisfied. Then, the candidate updated sparse function satisfying the training end condition may be determined as the target updated sparse function, and then the target updated sparse function updates the target sparse function currently deployed in the target memory branch network.

The training end condition of the candidate updated sparse function may be set based on the following formula, or may be set based on other methods, which is not specifically limited here.

$${z}^{p , online} = {φ}^{″} ( {e}_{new}^{p} )$$

$$and$$

$${\hat{e}}_{new}^{p} = {( {z}^{p , online} )}^{T} D$$

$${\hat{e}}_{new}^{p}$$

represents the reconstructed pattern feature vector,

$${e}_{new}^{p}$$

represents the input pattern feature vector, φ″( ) represents the candidate updated sparse function, Z^{p,online} represents the mapped latent feature representation, and D represents the target codebook matrix.

That is, if the reconstructed pattern feature vector and the input pattern feature vector in a current training round satisfy the above two formulas, it may be determined that the candidate updated sparse function in the round satisfies the training end condition, and the candidate updated sparse function used in the round may be determined as the target updated sparse function.

In some embodiments, the target sparse function is updated based on the target updated sparse function.

An adjustment may be made to a portion of the target sparse function deployed in the target memory branch network that needs to be updated based on the target updated sparse function, thus achieving updating of the target sparse function.

In some embodiments, the target latent representation mapping table is updated by obtaining, through the target updated sparse function, an updated latent feature representation of the input pattern feature vector.

In the embodiments of the present disclosure, the sparse mapping may be performed on the input pattern feature vector through the target updated sparse function, and the sparse vector obtained by the sparse mapping is determined as the updated latent feature representation corresponding to the input pattern feature vector.

In this scenario, a mapping relationship construction algorithm in related technologies may be used to perform the algorithmic processing on the input token sequence corresponding to the input pattern feature vector and the updated latent feature representation, and then based on a result of the algorithmic processing, a mapping relationship between the input token sequence and the updated latent feature representation is constructed. Then, based on the input token sequence and the updated latent feature representation for which the mapping relationship has been constructed, a current target latent representation mapping table is updated.

In some embodiments, the target codebook matrix is updated by obtaining, through the target updated sparse function and the updated latent feature representation, a corresponding set of updated memory basis vectors.

As an example, the formula is shown in the following:

$${M}^{v , online} = \{ {z}_{\dot{t}}^{p , online} {d}_{i}^{D} \vert {z}_{i}^{p , online} \neq 0 \}$$

M^{v,online} represents a constructed set of updated memory basis vectors, Z^{p,online} represents the updated latent feature representation,

$${d}_{i}^{D}$$

and represents a memory basis vector. That is, for any memory basis vector, if a memory basis vector satisfies the above formula, the memory basis vector may be determined as an updated memory basis vector of the input token sequence.

In this scenario, an index relationship between the updated memory basis vector in the set of updated memory basis vectors and the updated latent feature representation may be constructed, and the target codebook matrix in the target memory branch network is updated based on the set of updated memory basis vectors after the index relationship is constructed.

At S203, a set of reference patterns of the large model is obtained.

In some embodiments, a set of historical patterns of the large model, and a historical accumulative occurrence count for each historical pattern in the set of historical patterns are obtained; and for any historical pattern, in response to the historical accumulative occurrence count of the historical pattern being greater than or equal to a preset occurrence count threshold, the historical pattern is determined as a reference pattern.

In the embodiments of the present disclosure, a pattern appearing in the large model and the target memory branch network within a set historical time range may be determined as a historical pattern, and then the set of historical patterns is obtained based on historical patterns.

In the embodiments of the present disclosure, an occurrence count of each historical pattern within the set historical time range may be recorded in a local cache. In this scenario, based on recorded data in the local cache, the historical accumulative occurrence count for each historical pattern may be obtained.

In some embodiments, for any historical pattern, a recorded historical accumulative occurrence count may be compared with the preset occurrence count threshold. When the historical accumulative occurrence count is greater than or equal to the threshold, it may be determined that the historical pattern is a historical pattern whose occurrence frequency in the large model and the target memory branch network is higher than a set value, and it may be further determined that the historical pattern is a pattern that is frequently needed during a daily operation of the large model. In this scenario, the historical pattern may be determined as the reference pattern, and then the corresponding set of reference patterns is obtained.

At S204, based on a target codebook matrix deployed in the target memory branch network, a set of target memory basis vectors corresponding to the associated latent feature representation is obtained.

In the embodiments of the present disclosure, the target memory branch network has a corresponding codebook matrix deployed therein, which may be determined as the target codebook matrix in the target memory branch network, in which the target codebook matrix stores a plurality of combinable memory basis vectors.

As an example, the target codebook matrix may be expressed by the following formula:

D represents the target codebook matrix, dₘₑₘ represents a number of elements of

D∈R^{d}^{ₘₑₘ}^{×d}^{_{basis}}

memory basis vectors included in the target codebook matrix, and d_{basis} represents a vector dimension of the memory basis vector.

In the embodiments of the present disclosure, each reference pattern in the set of reference patterns of the large model has an associated memory basis vector among the memory basis vectors included in the target codebook matrix.

In this scenario, a pattern reconstruction operation may be performed based on the memory basis vector, so as to obtain the target pattern of the input token sequence.

In some embodiments, from the target codebook matrix, a set of candidate memory basis vectors related to the associated latent feature representation is obtained, and a vector coefficient for each candidate memory basis vector is obtained.

In the embodiments of the present disclosure, elements constituting the associated latent feature representation may be determined as element representations included in the associated latent feature representation. For any element representation in the associated latent feature representation, the element representation has an associated memory basis vector in the target codebook matrix, in which there is an index relationship between the element representation and the memory basis vector.

In some embodiments, an index relationship for each element representation in the associated latent feature representation is obtained, and, from the target codebook matrix and based on the index relationship, a candidate memory basis vector associated with each element representation is obtained, so as to obtain the set of candidate memory basis vectors for the associated latent feature representation.

In the embodiments of the present disclosure, based on the above index relationship, from the target codebook matrix, a memory basis vector associated with each element representation in the associated latent feature representation is obtained, and the memory basis vector may be determined as the candidate memory basis vector.

In this scenario, based on the above method, the candidate memory basis vector of each element representation may be obtained, and then a corresponding set of candidate memory basis vectors is obtained based on each candidate memory basis vector.

In some embodiments, for any element representation, a feature value of the element representation is determined as a vector coefficient of a candidate memory basis vector associated with the element representation.

In the embodiments of the present disclosure, each element representation included in the associated latent feature representation has its own feature value, in which the feature value may be 0 or 1, which is not specifically limited here. In this scenario, for any element representation, the feature value of the element representation may be used as a coefficient of the candidate memory basis vector associated with the element representation, i.e., the vector coefficient.

In some embodiments, the set of target memory basis vectors is obtained by determining, from the set of candidate memory basis vectors and based on the vector coefficient for each candidate memory basis vector, activated target memory basis vectors.

In the embodiments of the present disclosure, the vector coefficients may be used to determine activated memory basis vectors and non-activated memory basis vectors from the set of candidate memory basis vectors. In a scenario where the feature value of the element representation is 0 or 1, a candidate memory basis vector with a vector coefficient of 0 may be determined as a non-activated memory basis vector, and a candidate memory basis vector with a vector coefficient of 1 may be determined as an activated memory basis vector.

The activated memory basis vector in the set of candidate memory basis vectors may be determined as a target memory basis vector, and then a corresponding set of target memory basis vectors is obtained based on target memory basis vectors.

As an example, as shown in FIG. 3, by an algorithmic process of “⊗” between the associated latent feature representation and the target codebook matrix, the set of candidate memory basis vectors {v₁, v₁, v₁, . . . , vₘ} for the associated latent feature representation may be obtained from the target codebook matrix. Assuming that the respective vector coefficients of {v₁, vₖ₊₁, vₖ₊₂, . . . , vₘ} are 0, and respective vector coefficients of {v₂, v₃, . . . , v₅} are 1, in this scenario, candidate memory basis vectors in {v₂, v₃, . . . , vₖ} may be determined as the activated target memory basis vectors, so as to obtain the set of target memory basis vectors Mᵥ={v₂, v₃, . . . , vₖ}.

At S205, the target pattern of the input token sequence is obtained based on the set of target memory basis vectors.

In the embodiments of the present disclosure, a preset pattern integration method may be used to perform vector integration on target memory basis vectors in the set of target memory basis vectors, and then the vector obtained after the integration is determined as the target pattern of the input token sequence.

It needs to be noted that after recalling the target pattern, an obtained target pattern may be returned to the backbone network of the large model, which may be understood in combination with the following content.

In some embodiments, an initial hidden state of the target memory branch network is obtained, and, based on the initial hidden state, a gating weight for each target memory basis vector in the target pattern is obtained.

In the embodiments of the present disclosure, the target memory branch network has a gating mechanism deployed therein, which may be understood in combination with the following

g^{v}^{ᵢ}=gate(hₜ,vᵢ)

formula:

hₜ represents a current initial hidden state of the target memory branch network, vᵢ represents the target memory basis vector, and g^{v}^{ᵢ} represents the gating weight of the target memory basis vector.

In some embodiments, a corresponding fused memory basis vector is obtained by performing, based on the gating weight for each target memory basis vector, weighted fusion on target memory basis vectors, and a target hidden state corresponding to the target pattern is obtained by performing residual fusion on the fused memory basis vector and the initial hidden state, and the target hidden state is returned to a backbone network of the large model.

As an example, it may be understood in combination with the following formula:

$${h}_{t}^{′} = Fuse ( {h}_{t} , {\sum }_{{v}_{i} ∈ {M}^{v}} {g}^{{v}_{i}} ⊙ {v}_{i} )$$

hₜ represents a target initial hidden state, hₜ represents the initial hidden state, vᵢ represents the target memory basis vector, g^{v}^{ᵢ} represents the gating weight of the target memory basis vector, and Fuse ( ) represents the residual fusion.

In this scenario, the target hidden state of the target pattern calculated by the above formula may be returned to the backbone network of the large model to participate in the algorithm operation of the large model.

In the method for recalling a pattern in the present disclosure, the target memory branch network is added to the backbone network of the large model without requiring training of the large model, thereby reducing the optimization cost of the large model and improving the optimization efficiency of the large model. The associated latent feature representation is obtained through the target latent representation mapping table derived from sparse mapping performed by the target sparse function, which improves the efficiency and accuracy of obtaining the latent feature representation, and further improves the accuracy and efficiency of obtaining the target pattern. There is no need to rely on the attention mechanism of the large model for token by token pattern reconstruction, which improves the efficiency of obtaining the target pattern and enhances the adaptability between the target pattern and the input token sequence. By adding the target memory branch network to the large model, a pathway for obtaining the pattern of the large model is increased, the method for obtaining the pattern is optimized, and the adaptability and practicality of the method for obtaining a pattern are improved. As a result, the operating efficiency of the large model is improved, and the model performance of the large model is further optimized.

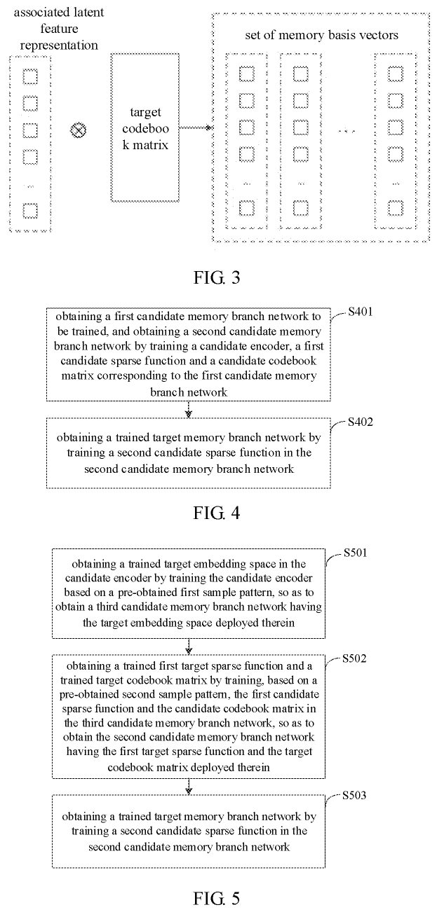

Regarding the target memory branch network in the above embodiments, before the target memory branch network participates in the algorithm operation of the large model, the target memory branch network needs to be trained, which may be understood with reference to FIG. 4. FIG. 4 is a flowchart of a method for training a memory branch network according to an embodiment of the present disclosure. As shown in FIG. 4, the method includes the following steps at S401 to S402.

At S401, a first candidate memory branch network to be trained is obtained, and a second candidate memory branch network is obtained by training a candidate encoder, a first candidate sparse function and a candidate codebook matrix corresponding to the first candidate memory branch network.

In the embodiments of the present disclosure, a memory branch network that needs to be trained may be determined as the first candidate memory branch network, in which the first candidate memory branch network needs to be deployed with an embedding space. In this scenario, an encoder to which the embedding space belongs may be obtained and used as the candidate encoder to be trained, and by training the candidate encoder, the embedding space to be deployed in the first candidate memory branch network is obtained.

In addition, a sparse mapping function and a codebook matrix in the first candidate memory branch network may also be trained and optimized, in which the sparse mapping function and the codebook matrix that need to be trained may be determined as the first candidate sparse function and the candidate codebook matrix.

In this scenario, the training method in related technologies may be used to train the first candidate sparse function and the candidate codebook matrix until training is completed, and a memory branch network having a trained embedding space deployed therein, a trained first candidate sparse function and a trained candidate codebook matrix is determined as the second candidate memory branch network.

At S402, a trained target memory branch network is obtained by training a second candidate sparse function in the second candidate memory branch network.

The target memory branch network is configured to implement the method for recalling a pattern in the embodiments of FIG. 1 to FIG. 3 above.

In the embodiments of the present disclosure, another sparse mapping function is also deployed in the second candidate memory branch network, which may be determined as the second candidate sparse function. By training the second candidate sparse function using a training method in related technologies, a trained second candidate sparse function may be obtained.

In this scenario, a second candidate memory branch network having the trained embedding space deployed therein, the trained first candidate sparse function, the trained candidate codebook matrix and the trained second candidate sparse function may be determined as the trained target memory branch network.

In the method for training a memory branch network in the present disclosure, the second candidate memory branch network is obtained by training the candidate encoder, the first candidate sparse function and the candidate codebook matrix respectively, and the target memory branch network is obtained by training the second candidate sparse matrix in the second candidate memory branch network. In the present disclosure, the target memory branch network is obtained via a plurality of training steps, which reduces the training complexity of the memory branch network, improves the convergence efficiency of the memory branch network, improves the robustness and stability of the target memory branch network, enhances the adaptability of the target memory branch network, and optimizes the model performance of the target memory branch network. In a scenario where the pattern is obtained based on the target memory branch network, the acquisition efficiency and accuracy of the pattern are improved, thus improving the operating efficiency and operating accuracy of the large model.

Regarding the acquisition of the target memory branch network in the above embodiment, it may also be understood with reference to FIG. 5. FIG. 5 is a flowchart of a method for training a memory branch network according to another embodiment of the present disclosure. As shown in FIG. 5, the method includes the following steps at S501 to S503.

At S501, a trained target embedding space in a candidate encoder is obtained by training the candidate encoder based on a pre-obtained first sample pattern, so as to obtain a third candidate memory branch network having the target embedding space deployed therein.

In the embodiments of the present disclosure, a pattern used when training the candidate encoder may be determined as a first sample pattern, in which the first sample pattern may be obtained using a method for obtaining a sample pattern in related technologies to train the candidate encoder.

In some embodiments, a training sample corresponding to the first sample pattern is obtained, in which the training sample is obtained by masking a sample context in a sample text to which the first sample pattern belongs.

In the embodiments of the present disclosure, a text to which the first sample pattern belongs may be determined as the sample text. In this scenario, context information of the sample text may be divided based on the first sample pattern, and divided context information is determined as the sample context corresponding to the first sample pattern in the sample text.

In this scenario, a sample masking method in related technologies may be used to perform masking processing on a divided sample context, and then the training sample of the candidate encoder is obtained based on masked sample data.

In some embodiments, a predicted token sequence output by the candidate encoder is obtained by predicting, through the candidate encoder, a token sequence associated with the first sample pattern in the sample context.

In the embodiments of the present disclosure, the first sample pattern may be input into the candidate encoder, and through the embedding space and the prediction layer deployed in the candidate encoder, a prediction is made for a token sequence that is likely to be associated with the first sample pattern in the sample context, and the output token sequence is determined as the predicted token sequence.

In some embodiments, a first loss value of the predicted token sequence relative to a labeled token sequence associated with the first sample pattern in the sample context is obtained, and the trained target embedding space is obtained by iterating a candidate embedding space in the candidate encoder based on the first loss.

In the embodiments of the present disclosure, the token sequence associated with the first sample pattern in the sample context may be determined as the labeled token sequence in the sample context.

In this scenario, a loss value algorithm in related technologies may be used to perform the algorithmic processing on the predicted token sequence and the labeled token sequence, and then based on a result of the algorithmic processing, a loss value of the predicted token sequence relative to the labeled token sequence is obtained as the first loss value. Then, based on the first loss value, an encoder that satisfies the training end condition is obtained by optimizing and iterating the candidate encoder, and the embedding space in the encoder that satisfies the training end condition is determined as a target embedding space to be deployed in the memory branch network.

In some embodiments, the third candidate memory branch network is obtained by updating the first candidate memory branch network based on the target embedding space.

That is, the target embedding space may be deployed in the first candidate memory branch network to update the first candidate memory branch network, and an updated network is determined as the third candidate memory branch network.

At S502, a trained first target sparse function and a trained target codebook matrix are obtained by training, based on a pre-obtained second sample pattern, the first candidate sparse function and the candidate codebook matrix in the third candidate memory branch network, so as to obtain the second candidate memory branch network having the first target sparse function and the target codebook matrix deployed therein.

In some embodiments, a first pattern feature vector of the second sample pattern is obtained by encoding, with the target embedding space, the second sample pattern.

In the embodiments of the present disclosure, a pattern used when training the third candidate memory branch network may be determined as the second sample pattern, in which the second sample pattern may be used to train the first candidate sparse function and the candidate codebook matrix in the third candidate memory branch network until each satisfy its own training end condition, and then a trained first candidate sparse function is determined as the first target sparse function, and a trained candidate codebook matrix is determined as the target codebook matrix.

The second sample pattern may be input into the target embedding space, and the second sample pattern is encoded through a target embedding space to obtain a feature vector corresponding to the second sample pattern, i.e., the first pattern feature vector.

For example, assuming that the second sample pattern is p={x₁, x₂, x₃, . . . , xₙ}, which may be input into the target embedding space, and overall encoding is performed on the second sample pattern through a target embedding space, so as to obtain the first pattern feature vector e^{p}.

In some embodiments, a first latent feature representation of the first pattern feature vector is obtained by performing, through the first candidate sparse function, sparse mapping on the first pattern feature vector.

As an example, assuming that φ( ) represents the first candidate sparse function and the first pattern feature vector is e^{p}={e^{x}^{₁}, e^{x}^{₂}, e^{x}^{₃}, . . . , e^{x}^{ₙ}}, performing the sparse mapping on the first pattern feature vector through the first candidate sparse function may be φ(e^{x}^{₁}, e^{x}^{₂}, e^{x}^{₃}, . . . , e^{x}^{ₙ}), and the vector may be determined as the first latent feature representation obtained after the sparse mapping of the first pattern feature vector.

In some embodiments, based on the first latent feature representation and the candidate codebook matrix, a corresponding set of candidate memory basis vectors is obtained, and a corresponding first reconstructed pattern feature vector is obtained based on the set of candidate memory basis vectors.

As an example, assuming that φ(e^{x}^{₁}, e^{x}^{₂}, e^{x}^{₃}, . . . , e^{x}^{ₙ}), et represents the first latent feature representation obtained by performing the sparse mapping on the first pattern feature vector through the first candidate sparse function, the first reconstructed pattern feature vector may be obtained based on the following formula:

φ(e^{x}^{₁},e^{x}^{₂},e^{x}^{₃}, . . . ,e^{x}^{ₙ})^{T}⊗D=e^{\hat{p}}

D represents the candidate codebook matrix, and e^{p} represents the first reconstructed pattern feature vector. That is, using the above formula, a memory basis vector associated with the first latent feature representation may be obtained from the candidate codebook matrix, and pattern vector reconstruction is performed based on the memory basis vector, and then a pattern vector obtained by reconstruction is determined as the first reconstructed pattern feature vector.

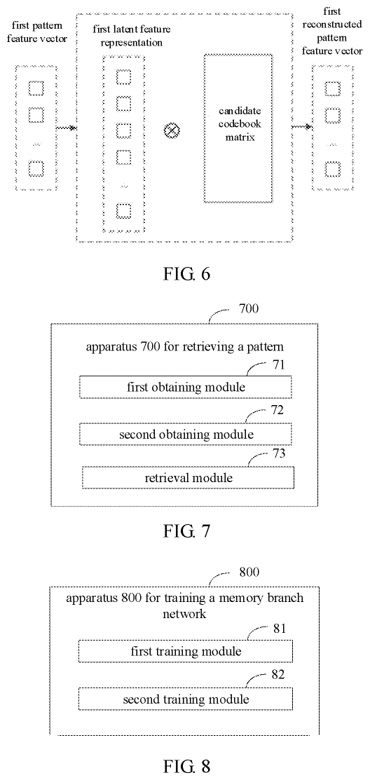

As an example, it may be understood with reference to FIG. 6. As shown in FIG. 6, the first latent feature representation corresponding to the first pattern feature vector shown in FIG. 6 may be obtained, and the first reconstructed pattern feature vector shown in FIG. 6 may be further obtained via algorithmic processing between the first latent feature representation and the candidate codebook matrix shown in FIG. 6.

In some embodiments, a second loss value of the first reconstructed pattern feature vector relative to the first pattern feature vector is obtained, and the first candidate sparse function and the candidate codebook matrix are optimized and iterated based on the second loss value, so as to obtain the trained first target sparse function and the trained target codebook matrix.

In the embodiments of the present disclosure, a loss value algorithm in related technologies may be used to perform the algorithmic processing on the first reconstructed pattern feature vector and the first pattern feature vector, and then based on a result of the algorithmic processing, a loss value of the first reconstructed pattern feature vector relative to the first pattern feature vector is obtained as the second loss value. In this scenario, an optimization method in related technologies may be used to optimize and iterate the first candidate sparse function and the candidate codebook matrix based on the second loss value until a training end condition is satisfied, so as to obtain the trained first target sparse function and the trained target codebook matrix.

As an example, the loss value algorithm may be as follows:

$$L ( p ) = {‖ {e}^{p} - {e}^{\hat{p}} ‖}_{2}^{2} + α {‖ φ ( \{ {e}^{{x}_{1}} , {e}^{{x}_{2}} , … , {e}^{{x}_{n}} \} ) ‖}_{1}$$

L(p) represents the second loss value, e^{p} represents the first pattern feature vector, e^{\hat{p}} represents the first reconstructed pattern feature vector, φ(e^{x}^{₁}, e^{x}^{₂}, e^{x}^{₃}, . . . , e^{x}^{ₙ}) represents the first latent feature representation, and a represents a hyperparameter used for weight balancing.

In some embodiments, the second candidate memory branch network is obtained by updating the third candidate memory branch network based on the first target sparse function and the target codebook matrix.

That is, the first target sparse function and the target codebook matrix may replace and update the first candidate sparse function and the candidate codebook matrix deployed in the third candidate memory branch network, and a branch network having the first target sparse function and the target codebook matrix deployed therein is determined as the second candidate memory branch network.

At S503, a trained target memory branch network is obtained by training a second candidate sparse function in the second candidate memory branch network.

In some embodiments, a sample token sequence is obtained, and a sample token sequence feature vector of the sample token sequence is obtained by encoding, through a target embedding space in the second candidate memory branch network, each sample token in the sample token sequence.

In the embodiments of the present disclosure, a token sequence used to train the second candidate sparse function deployed in the second candidate memory branch network may be determined as the sample token sequence. The sample token sequence includes a plurality of tokens, which may be determined as sample tokens included in the sample token sequence. In this scenario, the sample token sequence may be input into the second candidate memory branch network, and each sample token included therein is encoded respectively with a target embedding space, so as to obtain an overall encoding vector of the sample token sequence, i.e., the sample token sequence feature vector.

In some embodiments, a plurality of matching patterns for the sample token sequence are obtained, and by the target embedding space, a second pattern feature vector for each matching pattern among the plurality of matching patterns is obtained, so as to obtain a fused pattern feature vector for the second pattern feature vector.

In the embodiments of the present disclosure, the large model to which the trained target memory branch network needs to be connected has a corresponding set of reference patterns. Matching may be performed on each reference pattern included in the set based on the sample token sequence, so as to screen from the set of reference patterns a plurality of patterns that match the sample token sequence, i.e., the plurality of matching patterns.

A matching degree algorithm in related technologies may be used to perform the algorithmic processing on the sample token sequence and each reference pattern respectively to obtain a matching degree between the sample token sequence and each reference pattern, and then the plurality of patterns whose matching degrees satisfy a relevant condition are screened out as the plurality of matching patterns.

In this scenario, the plurality of matching patterns may be encoded respectively by the target embedding space to obtain their respective feature vectors for the plurality of matching patterns, i.e., the second pattern feature vector.

In this scenario, a weighted integration method in related technologies, or an attention-based summation integration method in related technologies, may be used to integrate second pattern feature vectors, and a vector obtained by integration is determined as the fused pattern feature vector of the second pattern feature vector.

In some embodiments, a second latent feature representation of the sample token sequence feature vector is obtained by performing, with the second candidate sparse function, sparse mapping on the sample token sequence feature vector, and a corresponding second reconstructed pattern feature vector is obtained based on the second latent feature representation and a target codebook matrix.

In the embodiments of the present disclosure, the sparse mapping may be performed on the sample token sequence feature vector with the second candidate sparse function, and an obtained sparse vector is determined as the second latent feature representation of the sample token sequence feature vector.

In this scenario, the algorithmic processing may be performed based on the second latent feature representation and the target codebook matrix to obtain a memory basis vector associated with the second latent feature representation from the target codebook matrix, and pattern vector reconstruction is performed based on the memory basis vector, and then a feature vector obtained by reconstruction is determined as the second reconstructed pattern feature vector.

In some embodiments, a third loss value of the second reconstructed pattern feature vector relative to the fused pattern feature vector is obtained, and a trained second target sparse function is obtained by optimizing and iterating the second candidate sparse function based on the third loss value.

In the embodiments of the present disclosure, a loss value algorithm in related technologies may be used to perform the algorithmic processing on the second reconstructed pattern feature vector and the fused pattern feature vector, and based on a result of the algorithmic processing, a loss value of the second reconstructed pattern feature vector relative to the fused pattern feature vector is obtained, i.e., the third loss value.

In this scenario, an optimization and iteration method in related technologies may be used to optimize and iterate the second candidate sparse function based on the third loss value until a second candidate sparse function that satisfies a training end condition is obtained, and then training may be ended, and the function that satisfies the training end condition is determined as the trained second target sparse function.

The algorithm of the third loss value may be the same as the algorithm of the second loss value above, or may be implemented by other loss value algorithms, which is not specifically limited here.

A corresponding training end condition may be set in combination with the following formula:

$${{φ}^{′} ( {e}^{{x}_{t}} , {e}^{{x}_{t - 1}} , {e}^{{x}_{t - 2}} , … , {e}^{{x}_{t - k}} )}^{T} ⊗ D \approx {\sum }_{i = 1}^{m} {e}^{{p}_{i}}$$

φ′(e^{x}^{₁}, e^{x}^{₂}, e^{x}^{₃}, . . . , e^{x}^{ₙ}), represents the second latent feature representation,

$${\sum }_{i = 1}^{m} {e}^{{p}_{i}}$$

represents the fused pattern feature vector, and D represents the target codebook matrix.

That is, when the second candidate sparse function satisfies a state shown in the above formula, it may be determined that the second candidate sparse function satisfies the training end condition.

In some embodiments, the target memory branch network is obtained by updating the second candidate memory branch network based on the second target sparse function.

The second candidate memory branch network may be updated based on the second target sparse function, and then a trained target memory branch network is obtained based on an updated branch network.

It needs to be noted that the first loss value, the second loss value and the third loss value mentioned in the above embodiments may also be used to adjust and optimize other model parameters in the memory branch network, which is not specifically limited here.

In the method for training a memory branch network in the present disclosure, the memory branch network is trained in a progressive and staged sequence, and the model training effect of the memory branch network is improved based on knowledge accumulation and reuse. The target memory branch network is obtained after a plurality of training steps, which reduces the training complexity of the memory branch network, improves the convergence efficiency of the memory branch network, and improves the robustness and stability of the target memory branch network.

An embodiment of the present disclosure also provides an apparatus for recalling a pattern. Since the apparatus for recalling a pattern in the embodiment of the present disclosure corresponds to the method for recalling a pattern in the above several embodiments, the implementation of the above method for recalling a pattern is also applicable to the apparatus for recalling a pattern in the embodiment of the present disclosure, and will not be described in detail in the following embodiments.

FIG. 7 is a block diagram of an apparatus for training a memory branch network according to an embodiment of the present disclosure. As shown in FIG. 7, an apparatus 700 for recalling a pattern includes a first obtaining module 71, a second obtaining module 72 and a recall module 73, in which the first obtaining module 71 is configured to obtain a target memory branch network of a large model, and obtain, through the target memory branch network, an associated latent feature representation of an input token sequence in an input text of the large model; the second obtaining module 72 is configured to obtain a set of reference patterns of the large model; and the recall module 73 is configured to obtain a target pattern of the input token sequence by performing, based on the associated latent feature representation and the set of reference patterns, recall of a pattern corresponding to the input token sequence.

In the embodiments of the present disclosure, the recall module 73 is further configured to: obtain, based on a target codebook matrix deployed in the target memory branch network, a set of target memory basis vectors corresponding to the associated latent feature representation; and obtain the target pattern of the input token sequence based on the set of target memory basis vectors.

In the embodiments of the present disclosure, the recall module 73 is further configured to: obtain, from the target codebook matrix, a set of candidate memory basis vectors related to the associated latent feature representation, and obtain a vector coefficient for each candidate memory basis vector; and obtain the set of target memory basis vectors by determining, from the set of candidate memory basis vectors and based on the vector coefficient for each candidate memory basis vector, activated target memory basis vectors.

In the embodiments of the present disclosure, the recall module 73 is further configured to: obtain an index relationship for each element representation in the associated latent feature representation, and obtain, from the target codebook matrix and based on the index relationship, a candidate memory basis vector associated with each element representation, so as to obtain the set of candidate memory basis vectors for the associated latent feature representation; and determine, for any element representation, a feature value of the element representation as a vector coefficient of a candidate memory basis vector associated with the element representation.

In the embodiments of the present disclosure, the first obtaining module 71 is further configured to: obtain, based on the set of reference patterns, a target latent representation mapping table deployed in the target memory branch network; and obtain, from the target latent representation mapping table and based on the input token sequence, the associated latent feature representation mapped from the input token sequence.

In the embodiments of the present disclosure, the first obtaining module 71 is further configured to: obtain, through a target embedding space in the target memory branch network, a reference pattern feature vector for each reference pattern in the set of reference patterns; obtain a reference latent feature representation for each reference pattern feature vector by performing, through a target sparse function in the target memory branch network, sparse mapping on each reference pattern feature vector; and construct the target latent representation mapping table based on reference patterns and reference latent feature representations.

In the embodiments of the present disclosure, the first obtaining module 71 is further configured to: in response to the input token sequence not being hit in the target latent representation mapping table, update an accumulative occurrence count of the input token sequence; and in response to an updated accumulative occurrence count being greater than or equal to a preset occurrence count threshold, update the target memory branch network based on the input token sequence.

In the embodiments of the present disclosure, the first obtaining module 71 is further configured to: obtain a set of input contexts corresponding to the input token sequence by collecting context information from an input text for each occurrence of the input token sequence; obtain, through a target embedding space in the target memory branch network and based on the set of input contexts, an input pattern feature vector corresponding to the input token sequence; and perform an update, based on the input pattern feature vector, of a target sparse function, the target latent representation mapping table, and a target codebook matrix in the target memory branch network.

In the embodiments of the present disclosure, the first obtaining module 71 is further configured to: obtain a candidate updated sparse function for the target sparse function, and obtain a trained target updated sparse function by training the candidate updated sparse function based on the input pattern feature vector; update the target sparse function based on the target updated sparse function; update the target latent representation mapping table by obtaining, through the target updated sparse function, an updated latent feature representation of the input pattern feature vector; and update the target codebook matrix by obtaining, through the target updated sparse function and the updated latent feature representation, a corresponding set of updated memory basis vectors.

In the embodiments of the present disclosure, the first obtaining module 71 is further configured to: obtain a mapped latent feature representation of the input pattern feature vector by performing, through the candidate updated sparse function, sparse mapping on the input pattern feature vector; obtain a corresponding reconstructed pattern feature vector by performing pattern reconstruction based on the mapped latent feature representation and the target codebook matrix; and obtain a function training loss of the reconstructed pattern feature vector relative to the input pattern feature vector, and obtain the target updated sparse function by training the candidate updated sparse function based on the function training loss until a training end condition is satisfied.

In the embodiments of the present disclosure, the second obtaining module 72 is further configured to: obtain a set of historical patterns of the large model, and a historical accumulative occurrence count for each historical pattern in the set of historical patterns; and for any historical pattern, in response to the historical accumulative occurrence count of the historical pattern being greater than or equal to a preset occurrence count threshold, determine the historical pattern as a reference pattern.

In the embodiments of the present disclosure, the apparatus further includes a mechanism fusion module, configured to: obtain an initial hidden state of the target memory branch network, and obtain, based on the initial hidden state, a gating weight for each target memory basis vector in the target pattern; and obtain a corresponding fused memory basis vector by performing, based on the gating weight for each target memory basis vector, weighted fusion on target memory basis vectors, and obtain a target hidden state corresponding to the target pattern by performing residual fusion on the fused memory basis vector and the initial hidden state, and return the target hidden state to a backbone network of the large model.

In the apparatus for recalling a pattern in the present disclosure, the target memory branch network of the large model is obtained, and, through the target memory branch network, the associated latent feature representation of the input token sequence is obtained. Then, based on the associated latent feature representation and the set of reference patterns, the target pattern is obtained by performing pattern recall on the input token sequence. In the present disclosure, the target memory branch network is added to the backbone network of the large model without a need to train the large model, which reduces an optimization cost of the large model and improves the optimization efficiency of the large model. By recalling the target pattern with the associated latent feature representation, there is no need to rely on an attention mechanism of the large model to reconstruct the pattern token by token, which improves the acquisition efficiency of the target pattern and the degree of adaptation between the target pattern and the input token sequence. By adding the target memory branch network to the large model, an additional path for obtaining the pattern of the large model is provided, the method for obtaining the pattern is optimized, the operating efficiency of the large model is improved, and the model performance of the large model is further optimized.

An embodiment of the present disclosure also provides an apparatus for training a memory branch network. Since the apparatus for training a memory branch network in the embodiment of the present disclosure corresponds to the method for training a memory branch network in the above several embodiments, the implementation of the above method for training a memory branch network is also applicable to the apparatus for training a memory branch network in the embodiment of the present disclosure, and will not be described in detail in the following embodiments.

FIG. 8 is a block diagram of an apparatus for training a classification model according to an embodiment of the present disclosure. As shown in FIG. 8, an apparatus 800 for training a memory branch network includes a first training module 81 and a second training module 82, in which the first training module 81 is configured to obtain a first candidate memory branch network to be trained, and obtain a second candidate memory branch network by training a candidate encoder, a first candidate sparse function and a candidate codebook matrix corresponding to the first candidate memory branch network; and the second training module 82 is configured to obtain a trained target memory branch network by training a second candidate sparse function in the second candidate memory branch network, in which the target memory branch network is configured to implement the apparatus for recalling a pattern in the embodiments of FIG. 7 above.

In the embodiments of the present disclosure, the first training module 81 is further configured to: obtain a trained target embedding space in the candidate encoder by training the candidate encoder based on a pre-obtained first sample pattern, so as to obtain a third candidate memory branch network having the target embedding space deployed therein; and obtain a trained first target sparse function and a trained target codebook matrix by training, based on a pre-obtained second sample pattern, the first candidate sparse function and the candidate codebook matrix in the third candidate memory branch network, so as to obtain the second candidate memory branch network having the first target sparse function and the target codebook matrix deployed therein.

In the embodiments of the present disclosure, the first training module 81 is further configured to: obtain a training sample corresponding to the first sample pattern, in which the training sample is obtained by masking a sample context in a sample text to which the first sample pattern belongs; obtain a predicted token sequence output by the candidate encoder by predicting, with the candidate encoder, a token sequence associated with the first sample pattern in the sample context; obtain a first loss value of the predicted token sequence relative to a labeled token sequence associated with the first sample pattern in the sample context, and obtain the trained target embedding space by iterating a candidate embedding space in the candidate encoder based on the first loss value; and obtain the third candidate memory branch network by updating the first candidate memory branch network based on the target embedding space.

In the embodiments of the present disclosure, the first training module 81 is further configured to: obtain a first pattern feature vector of the second sample pattern by encoding, with the target embedding space, the second sample pattern; obtain a first latent feature representation of the first pattern feature vector by performing, with the first candidate sparse function, sparse mapping on the first pattern feature vector; obtain, based on the first latent feature representation and the candidate codebook matrix, a corresponding set of candidate memory basis vectors, and obtain a corresponding first reconstructed pattern feature vector based on the set of candidate memory basis vectors; obtain a second loss value of the first reconstructed pattern feature vector relative to the first pattern feature vector, and optimize and iterate the first candidate sparse function and the candidate codebook matrix based on the second loss value, so as to obtain the trained first target sparse function and the trained target codebook matrix; and obtain the second candidate memory branch network by updating the third candidate memory branch network based on the first target sparse function and the target codebook matrix.

In the embodiments of the present disclosure, the second training module 82 is further configured to: obtain a sample token sequence, and obtain a sample token sequence feature vector of the sample token sequence by encoding, with a target embedding space in the second candidate memory branch network, each sample token in the sample token sequence; obtain a plurality of matching patterns for the sample token sequence, and obtain, by the target embedding space, a second pattern feature vector for each matching pattern among the plurality of matching patterns, so as to obtain a fused pattern feature vector for the second pattern feature vector; obtain a second latent feature representation of the sample token sequence feature vector by performing, with the second candidate sparse function, sparse mapping on the sample token sequence feature vector, and obtain a corresponding second reconstructed pattern feature vector based on the second latent feature representation and a target codebook matrix; obtain a third loss value of the second reconstructed pattern feature vector relative to the fused pattern feature vector, and obtain a trained second target sparse function by optimizing and iterating the second candidate sparse function based on the third loss value; and obtain the target memory branch network by updating the second candidate memory branch network based on the second target sparse function.

In the apparatus for training a memory branch network in the present disclosure, the second candidate memory branch network is obtained by training the candidate encoder, the first candidate sparse function and the candidate codebook matrix respectively, and the target memory branch network is obtained by training the second candidate sparse matrix in the second candidate memory branch network. In the present disclosure, the target memory branch network is obtained via a plurality of training steps, which reduces the training complexity of the memory branch network, improves the convergence efficiency of the memory branch network, improves the robustness and stability of the target memory branch network, enhances the adaptability of the target memory branch network, and optimizes the model performance of the target memory branch network. In a scenario where the pattern is obtained based on the target memory branch network, the acquisition efficiency and accuracy of the pattern are improved, thus improving the operating efficiency and operating accuracy of the large model.

According to the embodiments of the present disclosure, the present disclosure also provides an electronic device, a readable storage medium and a computer program product.

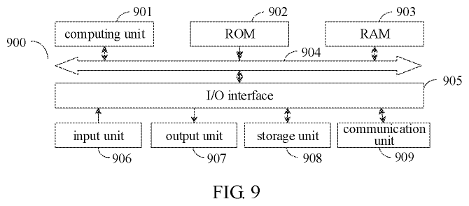

FIG. 9 is a block diagram of an example electronic device 900 to implement the embodiments of the present disclosure. The electronic device is intended to represent various types of digital computers, such as laptop computers, desktop computers, workstations, personal digital assistants, servers, blade servers, mainframe computers, and other suitable computers. The electronic device may also represent various types of mobile devices, such as personal digital assistants, cellular phones, smart phones, wearable devices, and other similar computing devices. The components shown herein, their connections and relations, and their functions are merely examples, which are not intended to limit the implementations of the disclosure described and/or required herein.

As shown in FIG. 9, the device 900 includes a computing unit 901, configured to execute various appropriate actions and processes according to a computer program stored in a read-only memory (ROM) 902 or a computer program loaded from a storage unit 908 to a random access memory (RAM) 903. The RAM 903 may store various programs and data required for an operation of the device 900. The computing unit 901, the ROM 902 and the RAM 903 may be connected with each other via buses 904. An input/output (I/O) interface 905 is also connected to the bus 904.

The plurality of components in the device 900 are connected to the I/O interface 905, including: an input unit 906, for example, a keyboard, a mouse, etc.; an output unit 907, for example, various types of displays, speakers, etc.; a storage unit 908, for example, a magnetic disk, an optical disk, etc.; and a communication unit 909, for example, a network card, a modem, a wireless transceiver, etc. The communication unit 909 allows the device 900 to exchange information/data via a computer network such as Internet and/or various types of telecommunication networks with other devices.

The computing unit 901 may be various types of general and/or dedicated processing components with processing and computing abilities. Some examples of the computing unit 901 include but not limited to a central processing unit (CPU), a graphics processing unit (GPU), various dedicated AI computing chips, various computing units on which a machine learning model algorithm is running, a digital signal processor (DSP), and any appropriate processor, controller, microcontroller, etc. The computing unit 901 executes various methods and processes as described above, for example, the method for recalling a pattern and/or the method for training a memory branch network. For example, in some embodiments, the method for recalling a pattern and/or the method for training a memory branch network may be further implemented as a computer software program, which is tangibly included in a machine readable medium, such as the storage unit 908. In some embodiments, a part or all of the computer program may be loaded and/or installed on the device 900 via the ROM 902 and/or the communication unit 909. When the computer program is loaded on the RAM 903 and executed by the computing unit 901, one or more steps in the method for recalling a pattern and/or the method for training a memory branch network may be performed as described above. In some embodiments, in other embodiments, the computing unit 901 may be configured to perform the method for recalling a pattern and/or the method for training a memory branch network in other appropriate ways (for example, by means of a firmware).

Various implementations of the systems and techniques described above may be implemented by one and/or a combination of a digital electronic circuit system, an integrated circuit system, a field-programmable gate array (FPGA), an application specific integrated circuit (ASIC), an application specific standard product (ASSP), a system on chip (SoC), a complex programmable logic device (CPLD), computer hardware, firmware, and software. These various embodiments may be implemented in one or more computer programs, in which the one or more computer programs may be executed and/or interpreted on a programmable system including at least one programmable processor. The programmable processor may be a dedicated or general programmable processor for receiving data and instructions from a storage system, at least one input device and at least one output device, and transmitting the data and the instructions to the storage system, the at least one input device and the at least one output device.

The program code configured to implement the method of the disclosure may be written in any combination of one or more programming languages. These program codes may be provided for processors or controllers of general-purpose computers, dedicated computers, or other programmable data processing devices, so that the program codes, when executed by the processors or the controllers, enable the functions/operations specified in the flowcharts and/or the block diagrams to be performed. The program code may be entirely executed on a machine, partly executed on a machine, partly executed on a machine and partly executed on a remote machine as an independent software package, or entirely executed on a remote machine or a server.

In the context of the disclosure, a machine-readable medium may be a tangible medium that may include or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the foregoing. More specific examples of machine-readable storage media include electrical connections based on one or more wires, portable computer disks, hard disks, RAMs, ROMs, electrically programmable read-only memories (EPROMs), flash memories, fiber optics, compact disc read-only memories (CD-ROMs), optical storage devices, magnetic storage devices, or any suitable combination of the foregoing.

In order to provide interaction with a user, the systems and techniques described herein may be implemented on a computer having a display device (e.g., a cathode ray tube (CRT) or a liquid crystal display (LCD) monitor) for displaying information to a user; and a keyboard and a pointing device (such as a mouse or trackball) via which the user may provide input to the computer. Other kinds of devices may also be used to provide interaction with the user. For example, the feedback provided to the user may be any form of sensory feedback (e.g., visual feedback, auditory feedback, or haptic feedback), and the input from the user may be received in any form (including acoustic input, voice input, or haptic input).

The systems and technologies described herein may be implemented in a computing system that includes background components (e.g., a data server), or a computing system that includes middleware components (e.g., an application server), or a computing system that includes front-end components (e.g., a user computer with a graphical user interface or a web browser, via which the user may interact with the implementations of the systems and technologies described herein), or may include any combination of the background components, the middleware components, and the front-end components. The components of the system may be interconnected by any form or medium of digital data communication (e.g., a communication network). Examples of the communication network include: a local area network (LAN), a wide area network (WAN), and the Internet.

The computer system may include a client and a server. The client and server are generally remote from each other and interacting through a communication network. A relationship between the client and the server is generated by computer programs running on corresponding computers and having a client-server relation with each other. The server may be a cloud server, a server of a distributed system, or a server combined with a block-chain.

It may be understood that various forms of processes shown above may be used to reorder, add or delete steps. For example, the steps described in the disclosure could be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions may be made according to design requirements and other factors. Any modification, equivalent replacement and improvement made within the spirit and principle of the disclosure shall be included in the protection scope of the disclosure.

1. A method for recalling a pattern, comprising:
obtaining a target memory branch network of a large model, and obtaining, through the target memory branch network, an associated latent feature representation of an input token sequence in an input text of the large model;
obtaining a set of reference patterns of the large model; and
obtaining a target pattern of the input token sequence by performing, based on the associated latent feature representation and the set of reference patterns, a recall of a pattern corresponding to the input token sequence.

2. The method of claim 1, wherein obtaining the target pattern of the input token sequence by performing, based on the associated latent feature representation and the set of reference patterns, the recall of the pattern corresponding to the input token sequence comprises:
obtaining, based on a target codebook matrix deployed in the target memory branch network, a set of target memory basis vectors corresponding to the associated latent feature representation; and
obtaining the target pattern of the input token sequence based on the set of target memory basis vectors.

3. The method of claim 2, wherein obtaining, based on the target codebook matrix deployed in the target memory branch network, the set of target memory basis vectors corresponding to the associated latent feature representation comprises:
obtaining, from the target codebook matrix, a set of candidate memory basis vectors related to the associated latent feature representation, and obtaining a vector coefficient for each candidate memory basis vector; and
obtaining the set of target memory basis vectors by determining, from the set of candidate memory basis vectors and based on the vector coefficient for each candidate memory basis vector, each activated target memory basis vector.

4. The method of claim 3, wherein obtaining, from the target codebook matrix, the set of candidate memory basis vectors related to the associated latent feature representation, and obtaining the vector coefficients for each candidate memory basis vector comprises:
obtaining an index relationship for each element representation in the associated latent feature representation, and obtaining, from the target codebook matrix and based on the index relationship, a candidate memory basis vector associated with each element representation, so as to obtain the set of candidate memory basis vectors for the associated latent feature representation; and
determining, for any element representation, a feature value of the element representation as a vector coefficient of a candidate memory basis vector associated with the element representation.

5. The method of claim 1, wherein obtaining the target memory branch network of the large model, and obtaining, through the target memory branch network, the associated latent feature representation of the input token sequence in the input text of the large model comprises:
obtaining, based on the set of reference patterns, a target latent representation mapping table deployed in the target memory branch network; and
obtaining, from the target latent representation mapping table and based on the input token sequence, the associated latent feature representation mapped from the input token sequence.

6. The method of claim 5, wherein obtaining, based on the set of reference patterns, the target latent representation mapping table deployed in the target memory branch network comprises:
obtaining, through a target embedding space in the target memory branch network, a reference pattern feature vector for each reference pattern in the set of reference patterns;
obtaining a reference latent feature representation for each reference pattern feature vector by performing, through a target sparse function in the target memory branch network, sparse mapping on each reference pattern feature vector; and
constructing the target latent representation mapping table based on reference patterns and reference latent feature representations.

7. The method of claim 5, further comprising:
in response to the input token sequence not being hit in the target latent representation mapping table, updating an accumulative occurrence count of the input token sequence; and
in response to an updated accumulative occurrence count being greater than or equal to a preset occurrence count threshold, updating the target memory branch network based on the input token sequence.

8. The method of claim 7, wherein, in response to the updated accumulative occurrence count being greater than or equal to the preset occurrence count threshold, updating the target memory branch network based on the input token sequence comprises:
obtaining a set of input contexts corresponding to the input token sequence by collecting context information from an input text for each occurrence of the input token sequence;
obtaining, through a target embedding space in the target memory branch network and based on the set of input contexts, an input pattern feature vector corresponding to the input token sequence; and
performing an update, based on the input pattern feature vector, of a target sparse function, the target latent representation mapping table, and a target codebook matrix in the target memory branch network.

9. The method of claim 8, wherein performing the update, based on the input pattern feature vector, of the target sparse function, the target latent representation mapping table and the target codebook matrix in the target memory branch network comprises:
obtaining a candidate updated sparse function for the target sparse function, and obtaining a trained target updated sparse function by training the candidate updated sparse function based on the input pattern feature vector;
updating the target sparse function based on the target updated sparse function;
updating the target latent representation mapping table by obtaining, through the target updated sparse function, an updated latent feature representation of the input pattern feature vector; and
updating the target codebook matrix by obtaining, through the target updated sparse function and the updated latent feature representation, a corresponding set of updated memory basis vectors.

10. The method of claim 9, wherein obtaining the candidate updated sparse function for the target sparse function, and obtaining the trained target updated sparse function by training the candidate updated sparse function based on the input pattern feature vector comprises:
obtaining a mapped latent feature representation of the input pattern feature vector by performing, through the candidate updated sparse function, sparse mapping on the input pattern feature vector;
obtaining a corresponding reconstructed pattern feature vector by performing pattern reconstruction based on the mapped latent feature representation and the target codebook matrix; and
obtaining a function training loss of the reconstructed pattern feature vector relative to the input pattern feature vector, and obtaining the target updated sparse function by training the candidate updated sparse function based on the function training loss until a training end condition is satisfied.

11. The method of claim 1, wherein obtaining the set of reference patterns of the large model comprises:
obtaining a set of historical patterns of the large model, and a historical accumulative occurrence count for each historical pattern in the set of historical patterns; and
for any historical pattern, in response to the historical accumulative occurrence count of the historical pattern being greater than or equal to a preset occurrence count threshold, determining the historical pattern as a reference pattern.

12. The method of claim 1, wherein after obtaining the target pattern of the input token sequence by performing, based on the associated latent feature representation and the set of reference patterns, the recall of the pattern corresponding to the input token sequence, the method further comprises:
obtaining an initial hidden state of the target memory branch network, and obtaining, based on the initial hidden state, a gating weight for each target memory basis vector in the target pattern; and
obtaining a corresponding fused memory basis vector by performing, based on the gating weight for each target memory basis vector, weighted fusion on each target memory basis vector, and obtaining a target hidden state corresponding to the target pattern by performing residual fusion on the fused memory basis vector and the initial hidden state, and returning the target hidden state to a backbone network of the large model.

13. A method for training a memory branch network, comprising:
obtaining a first candidate memory branch network to be trained, and obtaining a second candidate memory branch network by training a candidate encoder, a first candidate sparse function and a candidate codebook matrix corresponding to the first candidate memory branch network; and
obtaining a trained target memory branch network by training a second candidate sparse function in the second candidate memory branch network,
wherein the target memory branch network is configured to implement the method for recalling a pattern of claim 1.

14. The method of claim 13, wherein obtaining the first candidate memory branch network to be trained, and obtaining the second candidate memory branch network by training the candidate encoder, the first candidate sparse function and the candidate codebook matrix corresponding to the first candidate memory branch network comprises:
obtaining a trained target embedding space in the candidate encoder by training the candidate encoder based on a pre-obtained first sample pattern, so as to obtain a third candidate memory branch network having the target embedding space deployed therein; and
obtaining a trained first target sparse function and a trained target codebook matrix by training, based on a pre-obtained second sample pattern, the first candidate sparse function and the candidate codebook matrix in the third candidate memory branch network, so as to obtain the second candidate memory branch network having the first target sparse function and the target codebook matrix deployed therein.

15. The method of claim 14, wherein obtaining the trained target embedding space in the candidate encoder by training the candidate encoder based on the pre-obtained first sample pattern, so as to obtain the third candidate memory branch network having the target embedding space deployed therein comprises:
obtaining a training sample corresponding to the first sample pattern, wherein the training sample is obtained by masking a sample context in a sample text to which the first sample pattern belongs;
obtaining a predicted token sequence output by the candidate encoder by predicting, with the candidate encoder, a token sequence associated with the first sample pattern in the sample context;
obtaining a first loss value of the predicted token sequence relative to a labeled token sequence associated with the first sample pattern in the sample context, and obtaining the trained target embedding space by iterating a candidate embedding space in the candidate encoder based on the first loss value; and
obtaining the third candidate memory branch network by updating the first candidate memory branch network based on the target embedding space.

16. The method of claim 15, wherein obtaining the trained first target sparse function and the trained target codebook matrix by training, based on a pre-obtained second sample pattern, the first candidate sparse function and the candidate codebook matrix in the third candidate memory branch network, so as to obtain the second candidate memory branch network having the first target sparse function and the target codebook matrix deployed therein comprises:
obtaining a first pattern feature vector of the second sample pattern by encoding, with the target embedding space, the second sample pattern;
obtaining a first latent feature representation of the first pattern feature vector by performing, with the first candidate sparse function, sparse mapping on the first pattern feature vector;
obtaining, based on the first latent feature representation and the candidate codebook matrix, a corresponding set of candidate memory basis vectors, and obtaining a corresponding first reconstructed pattern feature vector based on the set of candidate memory basis vectors;
obtaining a second loss value of the first reconstructed pattern feature vector relative to the first pattern feature vector, and optimizing and iterating the first candidate sparse function and the candidate codebook matrix based on the second loss value, so as to obtain the trained first target sparse function and the trained target codebook matrix; and
obtaining the second candidate memory branch network by updating the third candidate memory branch network based on the first target sparse function and the target codebook matrix.

17. The method of claim 13, wherein obtaining the trained target memory branch network by training the second candidate sparse function in the second candidate memory branch network comprises:
obtaining a sample token sequence, and obtaining a sample token sequence feature vector of the sample token sequence by encoding, with a target embedding space in the second candidate memory branch network, each sample token in the sample token sequence;
obtaining a plurality of matching patterns for the sample token sequence, and obtaining, by the target embedding space, a second pattern feature vector for each matching pattern among the plurality of matching patterns, so as to obtain a fused pattern feature vector for the second pattern feature vector;
obtaining a second latent feature representation of the sample token sequence feature vector by performing, with the second candidate sparse function, sparse mapping on the sample token sequence feature vector, and obtaining a corresponding second reconstructed pattern feature vector based on the second latent feature representation and a target codebook matrix;
obtaining a third loss value of the second reconstructed pattern feature vector relative to the fused pattern feature vector, and obtaining a trained second target sparse function by optimizing and iterating the second candidate sparse function based on the third loss value; and
obtaining the target memory branch network by updating the second candidate memory branch network based on the second target sparse function.

18. An electronic device, comprising:
at least one processor; and
a memory communicatively coupled to the at least one processor;
wherein the memory stores instructions that, when executed by the at least one processor, cause the at least one processor to:
obtain a target memory branch network of a large model, and obtaining, through the target memory branch network, an associated latent feature representation of an input token sequence in an input text of the large model;
obtain a set of reference patterns of the large model; and
obtain a target pattern of the input token sequence by performing, based on the associated latent feature representation and the set of reference patterns, a recall of a pattern corresponding to the input token sequence.

19. An electronic device, comprising:
at least one processor; and
a memory communicatively coupled to the at least one processor;
wherein the memory stores instructions that, when executed by the at least one processor, cause the at least one processor to perform the method of claim 13.

20. A non-transitory computer-readable storage medium for storing computer instructions, wherein the computer instructions are configured to cause a computer to perform the method of claim 1.
